(19) United States
(12) Patent Application Publication
(10) Pub. No.: US 2010/0146486 A1
(43) Pub. Date: Jun. 10, 2010

(54) ENTERPRISE SERVICE VALIDATION

(76) Inventors: Harish Mehta, Walldorf (DE); Abhay Tiple, St. Leon-Rot (DE)

Correspondence Address: SAP/BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/332,074

(22) Filed: Dec. 10, 2008

(51) Int. Cl. G06F 9/44

(52) U.S. Cl. 717/126

(57) ABSTRACT

Configuring a testing tool incorporated in a device to validate that a software component supplements enterprise services associated with an enterprise service architecture (ESA) for a business scenario to be executed on the ESA. The configuring of the testing tool is based on enterprise services associated with the ESA that are necessary to perform actions on data objects related to the business scenario, and requirements for each necessary enterprise service to interact with the data objects, business logic within the ESA, and the other necessary enterprise services. The software is then validated for the business scenario using the configured testing tool. The testing tool will generate result data indicating the software supplements enterprise services for the business scenario.

### FIELD

Embodiments of the invention relate to validation of system software, and more particularly to validation of system software based on existing enterprise services.

### BACKGROUND

Enterprise Service Architecture (ESA) may include a collection of services that may be structured as larger applications. The collection of services may be referred to as enterprise services. System hardware and software provide the resources for enterprise services. Enterprise services may work collectively to accomplish a task using various workflows—e.g., the services may share resources, work in a sequential manner, execute transactions based on atomicity, etc.

Coordinating enterprise services to work collectively may involve establishing communication between services and integrating the functionality of the services. It is also common for the enterprise services associated with an ESA to be required to not only perform tasks to completion, but to complete tasks according to specific metrics (e.g., time based metrics, performance base metrics, etc.).

When software is created to provide a new service or enhance an existing service, the functionality of the software is typically verified—i.e., the software will accept input and/or generate output as designed; however, validating the new or enhanced service provided by the software outside the context of the system (e.g., in the case of development of new or enhanced services by ISVs or independent software vendors of enterprise systems) does not necessarily guarantee the service is compliant with the rest of the enterprise services. Thus, ISVs may follow established guidelines for software development, but there may still fail to be validation that existing services utilizing the software will execute the specific tasks the ESA is designed to complete, or that the tasks will be completed according to specific metrics.

### BRIEF DESCRIPTION OF THE DRAWINGS

The following description includes discussion of figures having illustrations given by way of example of implementations of embodiments of the invention. The drawings should be understood by way of example, and not by way of limitation. As used herein, references to one or more “embodiments” are to be understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive.

FIG. 1 is a block diagram of an embodiment of a testing tool configured to validate software supplementing enterprise services for a business scenario.

FIG. 2 is a block diagram of an embodiment of configuration data used to configure a testing tool.

FIG. 2A is a block diagram of an embodiment of an ESA-based system.

FIG. 2B is a flow diagram of an embodiment of a business scenario.

FIG. 2C is a block diagram of an embodiment of a data object used by a service.

FIG. 3 is a flow diagram of an embodiment of a process for configuring a testing tool to validate software designed to supplement enterprise services.

FIG. 4 is a block diagram of an embodiment of configuration logic used to configure a testing tool.

Descriptions of certain details and implementations follow, including a description of the figures, which may depict some or all of the embodiments described below, as well as discussing other potential embodiments or implementations of the inventive concepts presented herein. An overview of embodiments of the invention is provided below, followed by a more detailed description with reference to the drawings.

### DETAILED DESCRIPTION

Embodiments of the present invention relate to validating software for a business scenario. Embodiments of the present invention may be represented by a configurable testing tool.

In one embodiment, software is validated to supplement enterprise services associated with an Enterprise Service Architecture (ESA) using a configurable testing tool. The testing tool may be configured to validate the software according to a business scenario. The testing tool may be further configured based on the enterprise services necessary to perform the business scenario, the data objects used by the enterprise services, and the coordination requirements of the enterprise services, the data objects and the business logic of the ESA-based system.

As described herein, software may be designed to supplement enterprise services—i.e., provide a new service or enhance an existing service. Such software may be designed after the enterprise services to be supplemented have already been deployed on to a system. Thus, the software, working collectively with the pre-existing enterprise services, may fail to complete specific business tasks. The software may also fail to complete the tasks according to specific metrics—e.g., response time, completion time, acceptable error percentage. etc.

Prior art testing tools would allow the functionality of the software to be verified—i.e., that the software executes instructions as designed; however, prior art testing tools would not allow the software to be validated with respect to application of the services in conjunction with the execution of a business scenario. Furthermore, prior art testing tools would not allow the software to be validated according to metrics associated with the business scenario. As used herein, a business scenario refers to multiple enterprise services within an ESA-based system coupled together in the form of request-to-perform (RTP) relationships. As used herein, enterprise services refer to web-services in a business context.

In one embodiment, the testing tool is configured by configuration logic. The testing tool may be configured based on a business scenario to be executed using the new or enhanced service. The testing tool may be further configured based on data describing the enterprise services, data objects, and business logic of the ESA-based system. By configuring a testing tool with such data, software may be validated to adhere to a specific programming model prior to installation and integration within an ESA based system.

The testing tool may be configured further based on specific metrics associated with the business scenario. An example of a set of specific metrics associated with the business scenario is a Service Level Agreement (SLA). An SLA may define business scenario metrics. An example of metrics defined by an SLA would be metrics directed towards time of completion. Therefore, software capable of executing the tasks related to the business scenario alone would not necessarily be validated according to the SLA—the tasks would have to be completed within a specific time frame.

Enterprise services often require the use of data objects related to the ESA-based system. In one embodiment, the testing tool is configured based on data objects used by the enterprise services. An example of a specific data object used by ESA-based systems is a business object. Business objects are data objects comprising several layers of information related to the ESA-based system. Software designed to supplement enterprise services but not compatible with the structure of the business objects used within the system will not be validated by the testing tool.

Enterprise services may work with external data in addition to data objects. In one embodiment, configuration logic may further generate random data to provide to the testing tool. The random data generated may be modeled after input typically received by the enterprise services when the business scenario is executed. Such data may provide corner case stimulus to achieve a more thorough validation of the software.

Enterprise services may define documentation describing service functionality. In one embodiment, the testing tool is configured to validate that the documentation provided by the software's new or enhanced service is consistent with the documentation of the pre-existing enterprise services.

In one embodiment, the testing tool is further configured to validate the service defines the mapping and relational information of data objects. In another embodiment, the testing tool is further configured to validate that the service defined by the software is modeled according to applications that use the enterprise services.

The testing tool may further generate result data indicating a failure to validate that the software supplements the enterprise services for the business scenario. The testing tool may further generate suggestions that would enable validation of the software, based on the data generated, if the software fails validation.

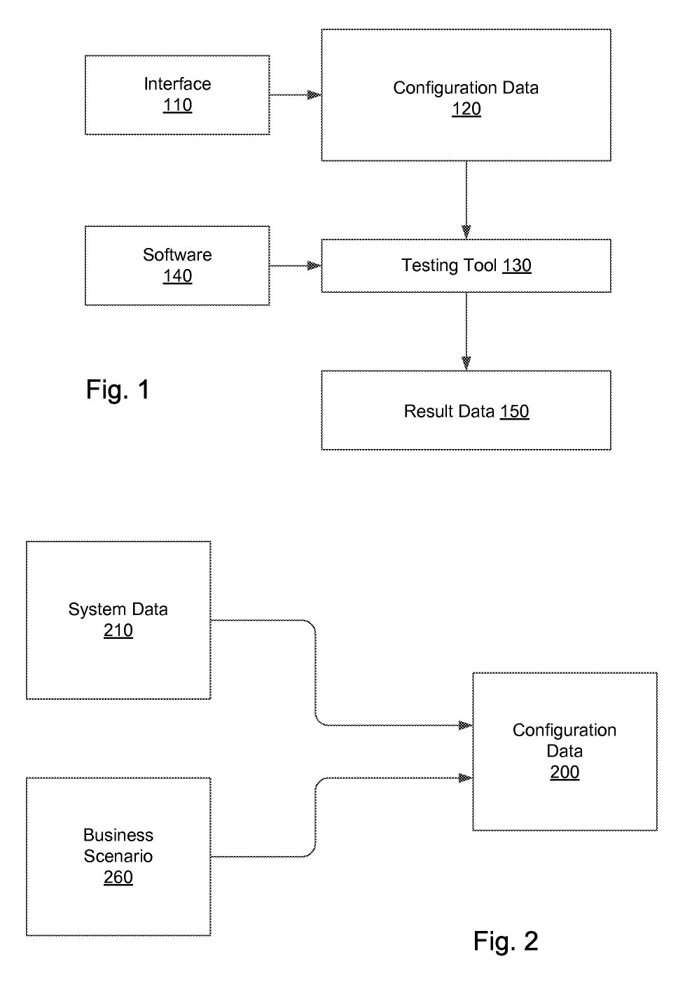

FIG. 1 is a block diagram of an embodiment of a configurable testing tool. Testing tool 130 may be configured to validate software 140 supplements enterprise services for a business scenario to be executed on an ESA-based system. Interface 110 may accept data defining the business scenario and the enterprise services required to execute the business scenario. In one embodiment, interface 110 is a graphical user interface (GUI). Other validation criteria that may be accepted by interface 110 include the data objects used by the enterprise services and business logic within the ESA-based system. Interface 110 may also accept service criteria defining how the tasks related to the business scenario must be executed.

Interface 110 may also receive files that define validation criteria. For example, validation criteria may be defined as an Extensible Markup Language (XML) schema from an XML file. Enterprise services may be defined by Web Service Description Language (WSDL). Files containing an XML schema or defining the enterprise service via WSDL may be contained on machine readable storage medium including any mechanism that provides (i.e., stores and/or transmits) information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). The validation criteria provided to interface 110 should provide enough detail to enable testing tool 130 to validate that the service created or enhanced by software 140 will functionally integrate with existing enterprise services. In one embodiment, a user is prompted at interface 110 to provide a file that includes pre-defined validation and SLA criteria. If the user provides no file, or if the file does not completely define the criteria necessary to validate software 140, the user may be prompted to input the sufficient criteria via interface 110. Sufficient criteria may include a description of the existing enterprise services, enterprise service architecture, and a business scenario to be executed.

The data from interface 110 is used as configuration data 120. Configuration data 120 is used configure testing tool 130. In one embodiment, testing tool 130 contains the logic necessary to utilize configuration data 120. In another embodiment, testing tool 130 is coupled to such configuration logic. Testing tool 130 validates that software 140 supplements enterprise services associated with an ESA-based system for a business scenario to be executed on the ESA-based system.

Testing tool 130 may be further configured to validate software 140 satisfies additional requirements. For example, a user may be prompted at interface 110 to enable metadata testing. Metadata may include classification and mapping information used by the service defined by software 140. Metadata may be used to describe the state, surroundings and the behavior of the service defined by software 140. Metadata may need to be verified to contain mandatory classifications in order to functionally integrate with the existing enterprise services.

A user may be further prompted at interface 110 to input data that may be accepted by any of the enterprise services when a business scenario is executed. For example, the user may be prompted to select an option to have the configuration logic generate random data for testing tool 130 to use during the testing of software 140. If the user declines to enable random data generation, the user may be prompted at interface 110 to supply such data, either manually or by supplying a file containing such data.

A user may be further prompted at interface 110 to enable service documentation validation. The user may specify that the documentation exists within software 140, or the user may provide the documentation to the configuration logic in a file or in a specific location (e.g., a file location within the system that includes the testing tool, a URL, etc.). Such documentation may be validated by testing tool 130 to be consistent with the existing documentation of the existing enterprise services.

A user may be further prompted at interface 110 to enable modeling status verification so that testing tool 130 may verify that the service defined by software 140 is modeled according to existing enterprise services and applications that may use the enterprise services. In one embodiment, this is option may be enabled by the user at interface 110.

A user may be further prompted at interface 110 to define variable test settings, such as iteration, load testing, and multi user setup settings. In one embodiment, interface 110 displays a default listing of test settings, and the user may change any or all such settings manually. In another embodiment, interface 110 displays several pre-defined test settings for the user to select.

In one embodiment, a user is prompted at interface 110 to execute testing tool 130 to validate software 140 after testing tool 130 has been configured via configuration data 120. Testing tool 130 may then execute to determine if software 140 will functionally integrate with existing enterprise services, and if software 140 satisfies any additional validation tests enabled. Testing tool 130 may generate result data 150 indicating software 140 supplements enterprise services for the business scenario. In one embodiment, testing tool 130 generates suggestions that would enable validation of software 140, based on result data 150, if software 140 fails validation.

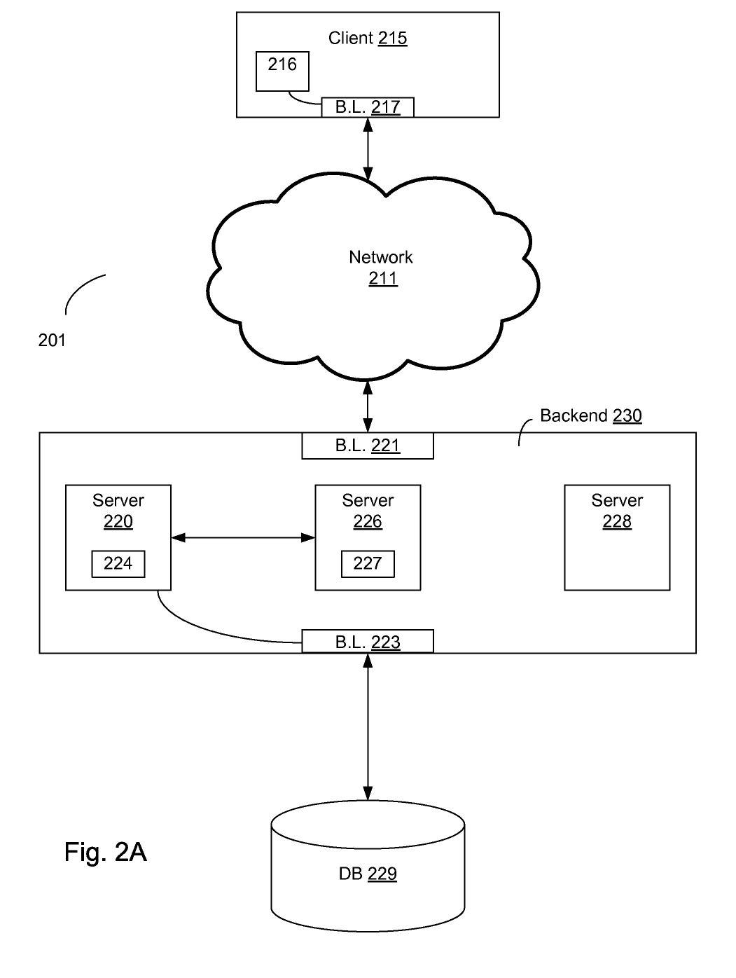

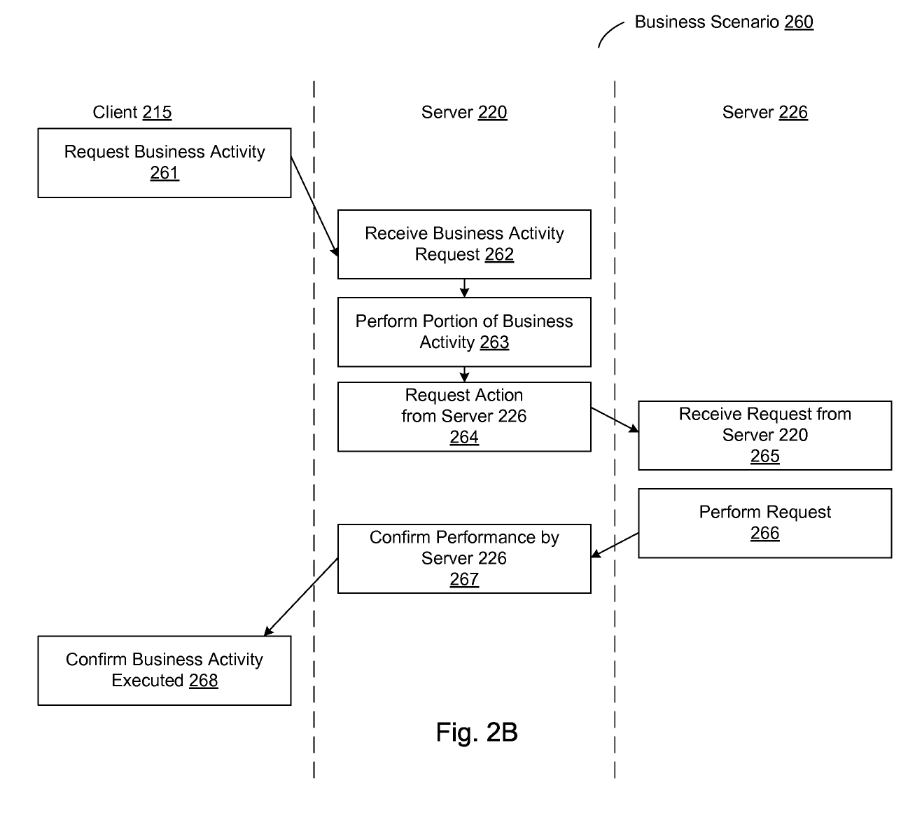

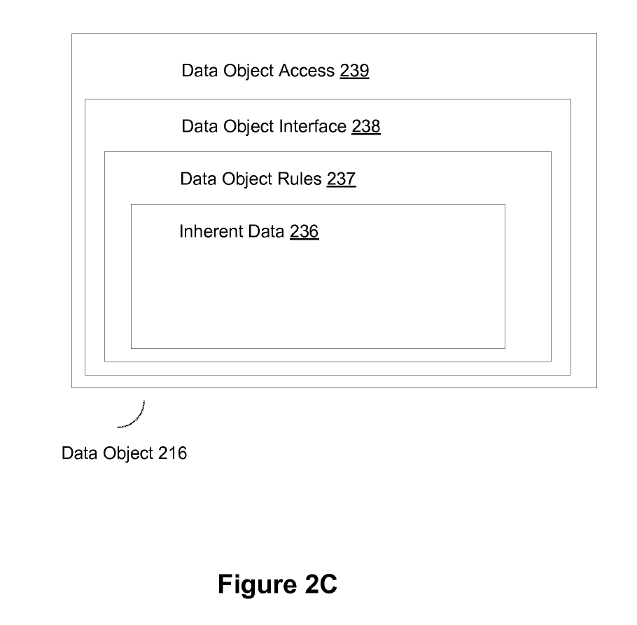

FIG. 2 is a block diagram of an embodiment of configuration data used to configure a testing tool. Configuration data 200 may comprise system data 210 and business scenario 260. System data 210 and business scenario 260 are depicted as separate boxes for illustrative purposes only. System data 210 and business scenario 260 may be interdependent. For example, system data 210 may comprise the enterprise services, data objects, and business logic of the ESA-based system involved in executing business scenario 260—i.e., system data 210 may comprise data related to a only a portion of the ESA-based system, the portion determined by business scenario 260.

In one embodiment, illustrated in FIGS. 2A, 2B and 2C, business scenario 260 may determine the enterprise services, business logic, data objects and other related infrastructure components of an ESA-based system that comprise system data 210.

FIG. 2A is a block diagram of an embodiment of an ESA-based system. ESA-based system 201 is used to define system data 210. In one embodiment, system 201 may be distributed across client 215, backend 230 and relational database 229. Client 215 and backend 230 connect through network 211 and business logic instances 217 and 221. Business logic 217 may comprise logic used to handle the exchange of information from client 215 to backend 230. Backend 230 and relational database 229 connect through business logic 223. Business logic 223 may comprise logic used to facilitate the exchange of information between backend 230 and relational database 229. For example, business logic 223 may comprise known object transfer protocols and/or known client/server protocols.

Client 215 may utilize data object 216. In one embodiment, data object 216 may represent a unique table in relational database 229. In another embodiment, data object 216 may create a unique table in relational database 229.

Backend 230 may comprise servers 220, 226 and 228. As described below, a business scenario may only require the use of some of the available resources of system 201. For example, a business scenario may only require the use of servers 220 and 226. Servers 220 and 226 utilize data objects 224 and 227 respectively. Data objects 224 and 227 may be mapped to relational database 229 via business logic 223. Server 228 is illustrated as having no involvement in the execution of the business scenario. Backend 230 may comprise business logic 221 to interface with client 215, and business logic 221 to interface with database 229.

FIG. 2B is a flow diagram of an embodiment of a business scenario. Flow diagrams as illustrated herein provide examples of sequences of various process actions. Although shown in a particular sequence or order, unless otherwise specified, the order of the actions can be modified. Thus, the illustrated implementations should be understood only as examples, and the illustrated processes can be performed in a different order, and some actions may be performed in parallel. Additionally, one or more actions can be omitted in various embodiments of the invention; thus, not all actions are required in every implementation. Other process flows are possible.

Business scenario 260 may invoke a workflow distributed across multiple parts of a system to utilize the enterprise services of system 201. Business scenario 260 may comprise executing a business activity. A request for a business activity may invoke several enterprise services to fulfill the request, 261. This request may occur on client 215. The request for business activity requiring an enterprise service may be received at a server 220, 262. Data object 216 may be used by server 220 when performing the requested service.

The server 220 may perform a portion of the business activity, 263. The server 220 may request action from server 226, 264. Server 226 may receive the request from server 220, 265. Server 226 may perform the request, 266. Data object 227 may be used by server 226 when performing the requested service.

The server 220 may confirm server 226 performed the requested service, 267. For example, data object 227 may be mapped to relational database 229 via business logic 223, and server 220 may verify that requisite changes to a database have occurred via the service executed by server 226. Client may confirm completion of business activity request, 268. For example, data object 216 may be mapped to relational database 229 via business logic 223, and client may verify that requisite changes to a database have occurred via the service executed by server 220.

FIG. 2C is a block diagram of an embodiment of a data object used by a service. In one embodiment, the format of data object 216 is used by the enterprise services of system 201. Thus, software incompatible with the format of data object 216 will not be validated by the testing tool. In one embodiment, data objects used by system 201 are business objects. Business objects may comprise data structures with layers of additional data related to the business system. Inherent data 236 of business object 216 may comprise data to be used by enterprise services. For example, inherent data 236 may represent a unique table in database 229. Data object rules 237 may define consistency conditions and business rules applicable to the object. Data object interface 238 may comprise the interface used by other business objects or applications to access data object 216. For example, layer 238 may be defined by the business logic components of system 201. Data object access 239 may define how data object 216 is accessible external to system 201 (e.g., internet accessibility).

Thus, referring back to FIG. 2, a testing tool may be configured by configuration data 290. Configuration data 290 may comprise business scenario 260 and system data 210. Example embodiments of configuration data 290 are described above and illustrated in FIGS. 2A, 2B and 2C.

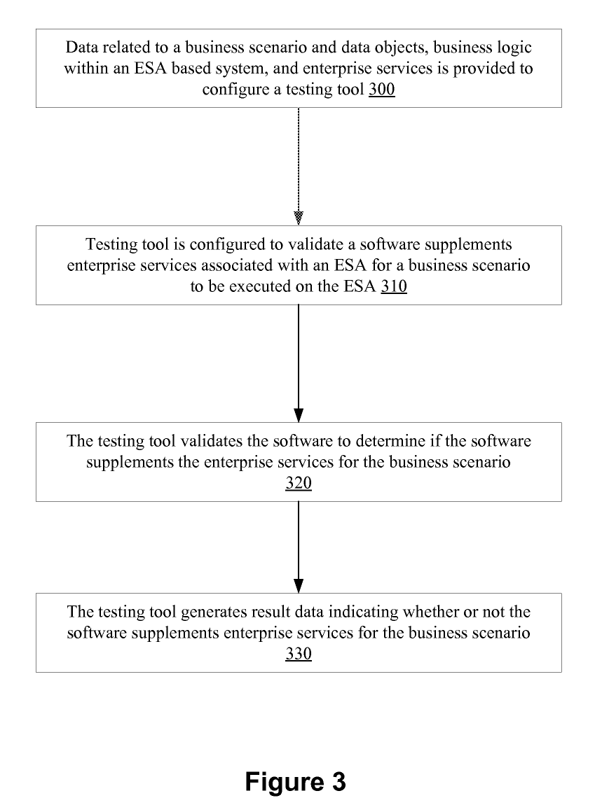

FIG. 3 is a flow diagram of an embodiment of a process for configuring a testing tool to validate software designed to supplement enterprise services. Data related to a business scenario to be executed on an ESA-based system is provided to configure a testing tool, 300. In one embodiment, a user interface allows a user to input information to be used as configuration data. A user may input enterprise services associated with the ESA-based system that are necessary to perform actions on data objects related to the business scenario. A user may also specify the requirements for each necessary enterprise service to interact with data objects, business logic within the ESA-based system, and the other necessary enterprise services. These requirements may include, but are not limited to, infrastructure specifications and requirements, structure of the data object, known services required by the business service, etc.

The data provided to configure a testing tool is used to configure a testing tool, 310. The testing tool may be configured to validate the software supplements enterprise services associated with an ESA for a business scenario to be executed on the ESA. The testing tool may be further configured to validate other aspects of the software. In one embodiment, the testing tool is configured to validate the documentation provided by the software's new or enhanced service is consistent with the documentation for the existing enterprise services. Validation of such documentation may be based on existing service documentation, defined parameters that must exist in the software source code, or a Uniform Resource Locator (URL) pointing to a documentation service.

In another embodiment, the testing tool may be configured by configuration data to validate how the new or enhanced service defines the mapping and relational information of data objects. Mapping and relational information of data objects may be defined by the software to be validated, or by a separate file.

The testing tool validates the software to determine if the software supplements the enterprise services for the business scenario, 320. In one embodiment, validation may include validating that the service executes the business scenario according to specific metrics. In another embodiment, the configured testing tool validates the software only if the software does not compromise the integration and service requirements of the enterprise services.

The testing tool generates result data indicating whether or not the software supplements enterprise services for the business scenario, 330. In one embodiment, the configured testing tool generates suggestions that would enable validation of the software. Such suggestions may be based on the result data generated by the testing tool if the software fails validation.

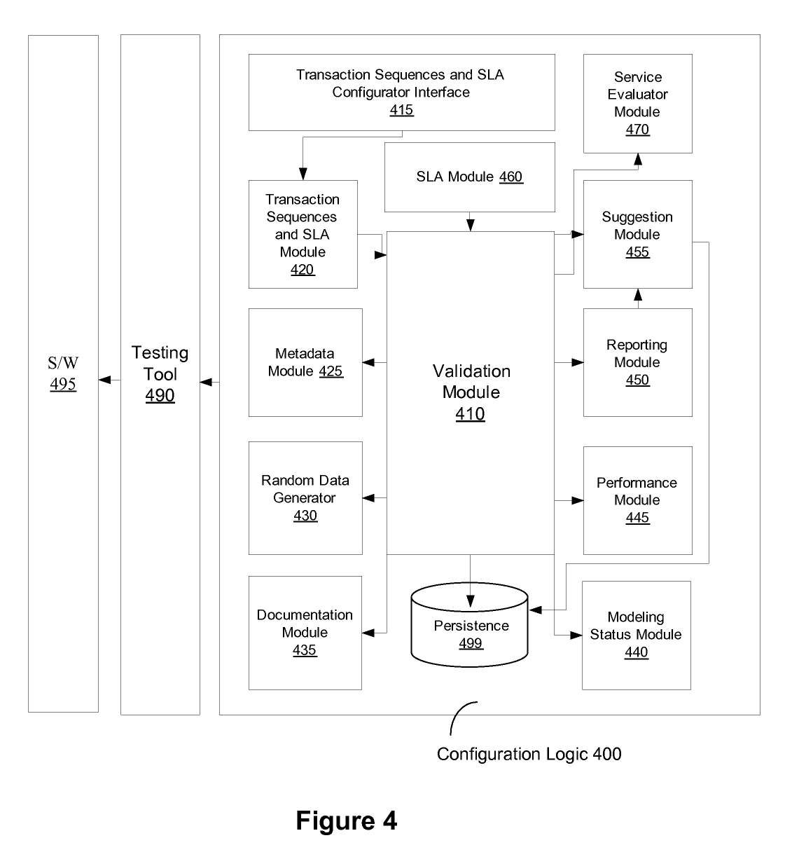

FIG. 4 is a block diagram of an embodiment of configuration logic used to configure a testing tool. Configuration logic 400 is used to configure testing tool 490. Testing tool 490 may be a computer aided test tool used to validate software 495. Software 495 may supplement existing enterprise services—i.e., software 495 may define a new service or define an enhancement to an existing service. Configuration logic 400 may consist of multiple components that cause testing tool 490 to validate various aspects of the new or enhanced service provided by software 495.

The multiple components illustrated in FIG. 4 are to be understood as an example embodiment only, and further embodiments may comprise any quantity or combination of the multiple components described herein. Furthermore, while configuration logic components illustrated in FIG. 4 are given descriptive labels, other labels could alternatively be applied to each component. All components illustrated in FIG. 4 are not necessary. In other embodiments, any component illustrated in FIG. 4 may be omitted. More than one instance of any of the component illustrated in FIG. 4 may be included in other embodiments.

In one embodiment, configuration logic components generate testing instructions, and testing tool 490 is configured to execute such instructions. In another embodiment, configuration logic components function as test executors, and testing tool 490 is be configured to execute each component.

In one embodiment, configuration logic 400 comprises several components. Each component may be used to validate different aspects of software 495. Validation module 410 is the hub of configuration logic 400. Validation module 410 may interface with the other components of configuration logic 400 (discussed below). Validation module 410 may invoke testing tool 490 functionality for running performance tests and/or validation tests. Validation module 410 provides the capability for defining custom transaction sequences, including system input data.

Transaction sequences and service level configuration interface 415 is an interface where the validation and Service Level Agreement (SLA) criteria may be defined. The level of specificity for testing may be defined by the input to interface 415. In one embodiment, interface 415 accepts user input to construct an entire set of validation criteria (including a business scenario) and enterprise service architecture (including data object structure, business logic, and enterprise services). In one embodiment, validation and SLA criteria are defined as XML schema within an XML file. Enterprise services may also be defined by a WSDL file. The XML and WSDL files may be provided to interface 415. Providing files to interface 415 may reduce the work of providing various options manually to interface 415. In another embodiment, a combination of both user input and file input are provided to interface 415. In another embodiment, interface 415 may accept additional data to be used to validate service functionality not covered by configuration logic components.

Transaction sequence and SLA module 420 is a module responsible for determining and loading the transactional sequences as well as the possible SLA's for the enterprise service, based on the data accepted at interface 415. The loaded transaction sequences may be provided to validation module 410. Validation module 410 may sort and provide the appropriate transactional sequences to other modules of configuration logic 400.

In one embodiment, Transaction sequence and SLA module 420 loads a set of common transaction sequences and SLAs by default. The default transaction sequences may be overridden whenever input is accepted from interface 415. If input is accepted at interface 415, such input is converted into a set of transaction sequences. For example, if XML and WSDL files are accepted at interface 415, Transaction sequence and SLA module 420 generates the equivalent transaction sequences.

SLA data may be provided to interface 415 and SLA module 460 may validate software 490 using such data. For example, an SLA may describe a “create sales order” service that requires a sales order to be created within 5 seconds. The service defined by software 495 may be validated to comply with the SLA description. SLA module 460 may validate an SLA description before using it to configure testing tool 490. SLA input may be included in the XML input as described above. SLA input may also be manually defined using interface 415.

Metadata module 425 may retrieve and validate classification and mapping information used by the service defined by software 495. Classification and mapping information may comprise additional attributes that describe the state, surroundings and behavior of the service. Such information may be included in the WSDL file provided by the user, or as additional input from user interface 415. In one embodiment, metadata module 425 checks for mandatory classifications contained or indicated in the metadata that are necessary to integrate the service defined by software 495 with existing enterprise services. In another embodiment, the efficiency of classifications and mapping used by the service defined by software 405 is validated by metadata module 425.

Random data generator 430 may generate random data resembling external data that may be accepted by the enterprise services when a business scenario is executed on the ESA-based system. The random data generated may be modeled after input typically received by the enterprise services when the business scenario is executed. Random data from generator 430 may be used by testing tool 490, or other configuration logic components as needed. Such data may provide corner case stimulus to achieve a more thorough validation of software 495.

Documentation module 435 may validate the documentation for the service defined by software 495. Such documentation may be part of a WSDL file provided to interface 415 or may be a URL pointing to a documentation service. In one embodiment, the service defined by software 495 may document the service provided. Such documentation is validated to be consistent with the existing documentation of the other enterprise services. In another embodiment, interface 415 may accept service documentation at interface 415 and verify the documentation using documentation module 435. In another embodiment, the documentation text is defined in a WSDL as plain text describing the service defined by software 495.

A separate software tool may manipulate service documentation validated by Documentation module 435 to describe a business process provided by the enterprise services. An example of such a software tool is SAP Solution Composer. This software tool creates textual and graphical representations of business processes provided by enterprise services based on service documentation. In one embodiment, documentation module 435 may validate the documentation for the service defined by software 495 is consistent with the requirements of this software tool.

Modeling status module 440 verifies the service defined by software 495 is modeled according to existing enterprise services and applications that may use the enterprise services. For example, existing enterprise services may collectively comprise a banking service modeled for a banking platform. While the service defined by software 495 may execute banking functionality properly, the service may further be validated to be modeled to produce a banking service according to the pre-existing banking platform.

Performance module 445 may specify performance details of tests executed by testing tool 490. The performance data may be based on the types of service requests received by the service defined by software 495, and the other related enterprise services. In one embodiment, the types of service requests may be defined by a business scenario. In another embodiment, the types of service requests may be defined at input 415. Performance module 445 may define variable test settings, such as iteration, load testing, and multi user setup settings, based on the performance data.

Reporting module 450 may collect, and/or format validation data produced by testing tool 490. Suggestion module 455 may output suggestions that would enable validation of the software, based on data from reporting module 450, if the software fails validation. Data from both reporting module 450 and suggestion module 455 may be stored in persistence 499.

Applications using enterprise services associated with an ESA may be required to be compatible with each other. Compatibility may be defined by service policy and security aspects. Service evaluator module 470 may validate the applications using the service defined by software 495 will remain compatible. In one embodiment, service evaluator module 470 verifies the service policy and security aspects of the service defined by software 495. Service evaluator module 470 may further validate that the service policy and security aspects of the service comply with the service policy and security aspects of the applications.

Various components referred to above as processes, servers, or tools described herein may be a means for performing the functions described. Each component described herein includes software or hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc. Software content (e.g., data, instructions, configuration) may be provided via an article of manufacture including a machine storage readable medium, which provides content that represents instructions that can be executed. The content may result in a machine performing various functions/operations described herein. A machine readable storage medium includes any mechanism that provides (i.e., stores and/or transmits) information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A machine readable storage medium may also include a storage or database from which content can be downloaded. A machine readable medium may also include a device or product having content stored thereon at a time of sale or delivery. Thus, delivering a device with stored content, or offering content for download over a communication medium may be understood as providing an article of manufacture with such content described herein.

1. A method comprising:
configuring a testing tool incorporated in a device to validate that a software component supplements enterprise services associated with an enterprise service architecture (ESA) for a business scenario to be executed on the ESA, the software component to provide a enterprise service functionality, the configuring based on
enterprise services associated with the ESA that are necessary to perform actions on data objects related to the business scenario, and
requirements for each necessary enterprise service to interact with the data objects, business logic within the ESA, and other necessary enterprise services;
validating the software supplements enterprise services for the business scenario with the device incorporating the configured testing tool; and
generating result data indicating the software supplements enterprise services for the business scenario.

2. The method of claim 1 wherein the enterprise services associated with the ESA provide documentation for the services provided, and the testing tool is further configured to validate the software documentation is consistent with the documentation of the enterprise services.

3. The method of claim 1, further comprising generating result data indicating the testing tool failed to validate the software supplements the enterprise services for the business scenario.

4. The method of claim 3, further comprising generating suggestions what would enable validation of the software, based on the data generated, if the software fails validation.

5. The method of claim 1 further comprising creating random data based on external data that may be accepted by the enterprise services when the business scenario is executed on the ESA, wherein the testing tool is configured further based on the random data.

6. The method of claim 1, wherein the testing tool is configured further based on mapping and relational information of the data objects.

7. The method of claim 1, wherein validating the software supplements enterprise services for the business scenario with the configured testing tool includes validating the supplemented enterprise services are modeled according to applications that use the enterprise services.

8. A system comprising:
a configurable software testing tool; and
configuration logic to configure the testing tool to validate that a software supplements enterprise services associated with an enterprise service architecture (ESA) for a business scenario to be executed on the ESA, the configuring based on
enterprise services associated with the ESA that are necessary to perform actions on data objects related to the business scenario, and
requirements for each necessary enterprise service to interact with the data objects, business logic within the ESA, and the other necessary enterprise service.

9. The system of claim 8, wherein the enterprise services associated with the ESA provide documentation for the services provided, and the software testing tool is further configured to validate the software documentation is consistent with the documentation of the enterprise services.

10. The system of claim 8, wherein the configurable software testing tool generates result data indicating the testing tool failed to validate the software supplements the enterprise services for the business scenario.

11. The system of claim 10, wherein the configurable software testing tool generates suggestions what would enable validation of the software, based on the data generated, if the software fails validation.

12. The system of claim 8, wherein the configuration logic further creates random data based on external data that may be accepted by the enterprise services when the business scenario is executed on the ESA, wherein the testing tool is configured further based on the random data.

13. The system of claim 8, wherein the testing tool is configured further based on mapping and relational information of the data objects.

14. The system of claim 8, wherein validating the software supplements enterprise services for the business scenario with the configured testing tool includes validating the supplemented enterprise services are modeled according to applications that use the enterprise services.

15. An article of manufacture comprising a computer-readable storage medium having instructions stored thereon to cause a processor to perform operations including:
configuring a testing tool incorporated to validate that a software component supplements enterprise services associated with an enterprise service architecture (ESA) for a business scenario to be executed on the ESA, the software component to provide a enterprise service functionality, the configuring based on
enterprise services associated with the ESA that are necessary to perform actions on data objects related to the business scenario, and
requirements for each necessary enterprise service to interact with the data objects, business logic within the ESA, and other necessary enterprise services;
validating the software supplements enterprise services for the business scenario with the configured testing tool; and
generating result data indicating the software supplements enterprise services for the business scenario.

16. The article of manufacture of claim 15 wherein the enterprise services associated with the ESA provide documentation for the services provided, and the testing tool is further configured to validate the software documentation is consistent with the documentation of the enterprise services.

17. The article of manufacture of claim 15, further comprising generating result data indicating the testing tool failed to validate the software supplements the enterprise services for the business scenario.

18. The article of manufacture of claim 17, further comprising generating suggestions what would enable validation of the software, based on the data generated, if the software fails validation.

19. The article of manufacture of claim 15 further comprising creating random data based on external data that may be accepted by the enterprise services when the business scenario is executed on the ESA, wherein the testing tool is configured further based on the random data.

20. The article of manufacture of claim 15, wherein the testing tool is configured further based on mapping and relational information of the data objects.

21. The article of manufacture of claim 15, wherein validating the software supplements enterprise services for the business scenario with the configured testing tool includes validating the supplemented enterprise services are modeled according to applications that use the enterprise services.
